(19) United States
(12) Patent Application Publication
(10) Pub. No.: US 2017/0134562 A1
(43) Pub. Date: May 11, 2017

(54) METHOD AND APPARATUS FOR CONTROL WIHD TRANSMISSION ON A MOBILE PHONE, AND A MOBILE PHONE

(71) Applicants: LE HOLDINGS (BEIJING) CO., LTD., BEIJING (CN); LEMOBILE INFORMATION TECHNOLOGY (BEIJING) CO., LTD., BEIJING (CN)

(72) Inventor: JUN LEI, BEIJING (CN)

(73) Assignees: LE HOLDINGS (BEIJING) CO., LTD., BEIJING (CN); LEMOBILE INFORMATION TECHNOLOGY (BEIJING) CO., LTD., BEIJING (CN)

(21) Appl. No.: 15/222,446

(22) Filed: Jul. 28, 2016

Related U.S. Application Data
(63) Continuation of application No. PCT/CN2016/082912, filed on May 20, 2016.

(30) Foreign Application Priority Data
Nov. 6, 2015 (CN) 201510756753.X

(51) Int. Cl. H04M 1/725; H04L 29/06

(52) U.S. Cl. CPC H04M 1/72563; H04L 65/60; H04L 65/80

(57) ABSTRACT

Disclosed are a method and apparatus for controlling WiHD transmission on a mobile phone, and a mobile phone, where the method for controlling WiHD transmission on a mobile phone includes: receiving a message indicating that a screen of the mobile phone becomes dark; detecting a kernel notification “PM_SUSPEND_PREPARE” of the mobile phone upon reception of the message indicating that the screen of the mobile phone becomes dark; and switching a state of WiHD transmission on the mobile phone according to a detection result. In the embodiments of the disclosure, if music is being played on the mobile phone, even if the screen of the mobile phone is dark, then WiHD transmission will still remain enabled so that the music being played on the mobile phone can be further WiHD-transmitted to thereby improve the experience of a user.

### CROSS-REFERENCE TO RELATED APPLICATIONS

This application is a continuation of International Application No. PCT/CN2016/082912, filed on May 20, 2016, which is based upon and claims priority to Chinese Patent Application No. 201510756753.X, filed with the Chinese Patent Office on Nov. 6, 2015 and entitled “a method and apparatus for control WiHD transmission on a mobile phone, and a related device”, which is hereby incorporated by reference in its entirety.

### TECHNICAL FIELD

The present disclosure relates to the field of communications, and particularly to a method and apparatus for control Wireless High-Definition (WiHD) transmission on a mobile phone, and a mobile phone.

### BACKGROUND

The technology of Wireless High-Definition (WiHD) refers to a high-speed wireless transmission technology in which a higher data transmission rate can be achieved in the spectrum of the 60 Kilo-Mega Hz (GHz) band (a millimeter wave), where the initial transmission rate is up to 4 Gbps, making it possible to provide more reliably a bandwidth necessary for transmitting a high-quality, high-definition, and uncompressed video.

The technology of WiHD can supplement all the other Wireless Local Area Network (WLAN) and Local Area Network (LAN) technologies, where data are transmitted at home over the WLAN or the LAN, and when the data are wireless transmitted to an indoor space and displayed, then the technology of WiHD will be a optimum selection due to its capability to display the high-quality, high-definition, uncompressed and lossless video.

The technology of WiHD can be applicable to a mobile phone, and if the mobile phone is provided with the function of WiHD, then data on a screen of the mobile phone can be delivered onto a TV set. In the prior art, if the screen of the mobile phone is bright, then the data displayed on the screen of the mobile phone will be delivered onto the TV set using the technology of WiHD, and if the screen of the mobile phone is dark, then the function of WiHD will be disabled, which is primarily caused by the following two reasons: firstly if the screen of the mobile phone is dark, then there will be no data displayed on the screen of the mobile phone, so there is no data displayed on the screen of the mobile phone to be delivered to the TV set using the technology of WiHD; and secondly if the screen of the mobile phone is dark, then the function of WiHD will be disabled to thereby lower power consumption. Thus in a general application, if the screen of the mobile phone is dark, then the function of WiHD will be disabled.

In an application, if a user is playing music on his or her mobile phone, then even if a screen of the mobile phone is dark, then the user may still further deliver the music in the mobile phone onto the TV set using the function of WiHD, but in fact, the function of WiHD is disabled directly because the screen of the mobile phone is dark, so that the music in the mobile phone can not be further delivered onto the TV set using the function of WiHD.

### SUMMARY

An object of embodiments of the disclosure is to provide a method and apparatus for controlling WiHD transmission on a mobile phone, and a mobile phone so that if music is being played on the mobile phone, then even if a screen of the mobile phone is dark, then the music being played on the mobile phone can still be further transmitted using the function of WiHD to thereby improve the experience of a user.

In order to attain this object, an embodiment of the disclosure provides a method for controlling WiHD transmission on a mobile phone, the method including:
receiving a message indicating that a screen of the mobile phone becomes dark;
detecting detect a kernel notification “PM_SUSPEND_PREPARE” of the mobile phone upon reception of the message indicating that the screen of the mobile phone becomes dark; and
switching a state of WiHD transmission on the mobile phone according to a detection result.

According to the method for controlling WiHD transmission on a mobile phone provided by the embodiment of the disclosure, when music is being played on the mobile phone, even if the screen of the mobile phone is dark, WiHD transmission will still remain enabled so that the music being played on the mobile phone can be further WiHD-transmitted, to thereby improve the experience of a user.

In order to attain this object, an embodiment of the disclosure provides an apparatus for controlling WiHD transmission on a mobile phone, the method including:
a first receiving module configured to receive a message indicating that a screen of the mobile phone becomes dark;
a detecting module configured to detect a kernel notification “PM_SUSPEND_PREPARE” of the mobile phone when the first receiving module receives the message indicating that the screen of the mobile phone becomes dark; and
a processing module configured to switch a state of WiHD transmission on the mobile phone according to a detection result of the detecting module.

According to the apparatus for controlling WiHD transmission on a mobile phone provided by the embodiment of the disclosure, when music is being played on the mobile phone, even if the screen of the mobile phone is dark, WiHD transmission will still remain enabled so that the music being played on the mobile phone can be further WiHD-transmitted, to thereby improve the experience of a user.

In order to attain the object above, an embodiment of the disclosure further provides a mobile phone including the apparatus for controlling WiHD transmission on a mobile phone according to the embodiments of the disclosure.

According to the mobile phone provided by the embodiment of the disclosure, when music is being played on the mobile phone according to the embodiment of the disclosure, even if the screen of the mobile phone is dark, WiHD transmission will still remain enabled so that the music being played on the mobile phone can be further WiHD-transmitted, to thereby improve the experience of a user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for controlling WiHD transmission on a mobile phone according to a first embodiment of the disclosure;

FIG. 2 is a flow chart of a method for controlling WiHD transmission on a mobile phone according to a second embodiment of the disclosure;

FIG. 3 is a structural block diagram of an apparatus for controlling WiHD transmission on a mobile phone according to a third embodiment of the disclosure;

FIG. 4 is a structural block diagram of an apparatus for controlling WiHD transmission on a mobile phone according to a fourth embodiment of the disclosure; and

FIG. 5 is a structural block diagram of a mobile phone according to a fifth embodiment of the disclosure.

### DESCRIPTION OF THE EMBODIMENTS

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

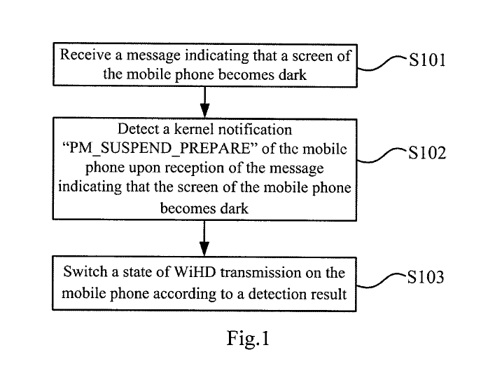

FIG. 1 is a flow chart of a method for controlling WiHD transmission on a mobile phone according to a first embodiment of the disclosure. The method for controlling WiHD transmission on a mobile phone illustrated in FIG. 1 is applicable to the mobile phone. As illustrated in FIG. 1, the method for controlling WiHD transmission on a mobile phone according to this embodiment can include the following steps:

The step S101 is to receive a message indicating that a screen of the mobile phone becomes dark.

Here the screen of the mobile phone being dark indicates that the screen of the mobile phone will be disabled.

In a particular application, it can be known in a number of ways that the screen of the mobile phone becomes dark. For example, many mobile phones can function to have their screens disabled automatically. If a preset length of time for which the screen is disabled automatically is reached, then the screen will be disabled automatically, that is, the screen will become dark. In this case, if the preset length of time for which the screen is disabled automatically is reached, then it can be determined that the message indicating that the screen of the mobile phone becomes dark is received.

In another example, when the screen of the mobile phone becomes dark, then the brightness of the screen will drop suddenly from a higher value to a lower value, so that if the brightness value of the screen turns form higher to lower, then it can be determined that the message indicating that the screen of the mobile phone becomes dark is received.

The step S102 is to detect a kernel notification “PM_SUSPEND_PREPARE” of the mobile phone upon reception of the message indicating that the screen of the mobile phone becomes dark.

If there is no music being played at the background of the mobile phone, then if the screen of the mobile phone becomes dark, then the mobile phone will try to go to sleep, so that a kernel of the mobile phone will transmit the kernel notification “PM_SUSPEND_PREPARE”. However if there is music being played at the background even after the screen of the mobile phone becomes dark, then the mobile phone will not try to go to sleep, so that the kernel of the mobile phone will not transmit any kernel notification “PM_SUSPEND_PREPARE”.

With this mechanism, in this step, the kernel notification “PM_SUSPEND_PREPARE” will be detected instead of disabling the function of WiHD immediately after the screen of the mobile phone becomes dark. If a kernel notification “PM_SUSPEND_PREPARE” is received, which indicates that there is no music being played at the background of the mobile phone at that time, then the function of WiHD will be disabled; and if no kernel notification “PM_SUSPEND_PREPARE” is received, which indicates that there is music being played at the background of the mobile phone at that time, then the function of WiHD will remained enabled because the user still intends to transmit the music being played at the background of the mobile phone onto another device (e.g., a TV set).

In an embodiment of the disclosure, a detection function can be registered in the kernel of the mobile phone to detect the kernel notification “PM_SUSPEND_PREPARE”.

The step S103 is to switch a state of WiHD transmission on the mobile phone according to a detection result.

The state of WiHD transmission refers to the function of WiHD being enabled or disabled.

In an embodiment of the disclosure, to switch a state of WiHD transmission on the mobile phone according to a detection result includes:

If the detection result is that the kernel notification “PM_SUSPEND_PREPARE” is detected, then WiHD transmission on the mobile phone will be disabled.

In an embodiment of the disclosure, to switch a state of WiHD transmission on the mobile phone according to a detection result includes:

If the detection result is that the kernel notification “PM_SUSPEND_PREPARE” is not detected, then WiHD transmission on the mobile phone will remain enabled.

With the method for controlling WiHD transmission on a mobile phone according to the embodiment of the disclosure, if music is being played on the mobile phone, even the screen of the mobile phone is dark, WiHD transmission will still remain enabled so that the music being played on the mobile phone can be further WiHD-transmitted, to thereby improve the experience of a user.

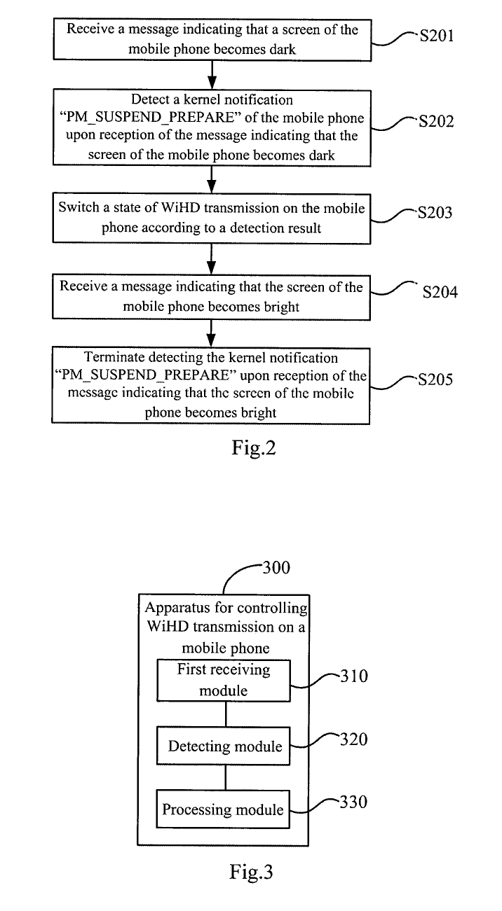

FIG. 2 is a flow chart of a method for controlling WiHD transmission on a mobile phone according to a second embodiment of the disclosure. The method for controlling WiHD transmission on a mobile phone illustrated in FIG. 2 is applicable to the mobile phone. As illustrated in FIG. 2, the method for controlling WiHD transmission on a mobile phone according to this embodiment can include the following steps:

The step S201 is to receive a message indicating that a screen of the mobile becomes dark;

The step S202 is to detect a kernel notification “PM_SUSPEND_PREPARE” of the mobile phone upon reception of the message indicating that the screen of the mobile becomes dark;

In an embodiment of the disclosure, a detection function can be registered in the kernel of the mobile phone to detect the kernel notification “PM_SUSPEND_PREPARE”

The step S203 is to switch a state of WiHD transmission on the mobile phone according to a detection result.

The step S204 is to receive a message indicating that the screen of the mobile phone becomes bright;

Here the screen of the mobile phone being bright indicates that the screen of the mobile phone will be enabled.

In a particular application, it can be known in a number of ways that the screen of the mobile phone becomes bright. For example, many mobile phones can function to have their screens locked, and if a user unlocks the screen, then the screen will be enabled automatically, that is, the screen of the mobile phone will become bright. In this case, when the user unlocks the screen, then it can be determined that the message indicating that the screen of the mobile phone becomes bright is received.

In another example, as opposed to the screen of the mobile phone becoming dark, when the screen of the mobile phone becomes bright, then the brightness of the screen will rise suddenly from a lower value to a higher value, so that if the brightness value of the screen turns from lower to higher, then it can be determined that the message indicating that the screen of the mobile phone becomes bright is received.

The step S205 is to terminate detecting the kernel notification “PM_SUSPEND_PREPARE” upon reception of the message indicating that the screen of the mobile phone becomes bright.

In correspondence to the step S202, the message indicating that the screen of the mobile phone becomes bright can be terminated from being detected, by deregistering the detection function in the kernel of the mobile phone in an embodiment of the disclosure.

Since the function of WiHD transmits data displayed on the screen of the mobile phone to a TV set or another device for displaying when the screen of the mobile phone is bright, the function of WiHD will remain enabled while the screen is bright, and at this time, there is no need to detect the kernel notification “PM_SUSPEND_PREPARE” to thereby determine whether to further remain WiHD transmission enabled. Thus the kernel notification “PM_SUSPEND_PREPARE” will be terminated from being detected in this step upon reception of the message indicating that the screen of the mobile phone becomes bright. Since the termination operation may have a corresponding application in the mobile phone disabled, memory resources of the mobile phone can be saved, and the response speed of the mobile phone can be improved.

With the method for controlling WiHD transmission on a mobile phone according to the embodiment of the disclosure, if music is being played on the mobile phone, then even if the screen of the mobile phone is dark, then WiHD transmission will still remain enabled so that the music being played on the mobile phone can still be further WiHD-transmitted to thereby improve the experience of the user. Moreover with the method for controlling WiHD transmission on a mobile phone according to the embodiment of the disclosure, if the screen of the mobile phone is bright, then the kernel notification “PM_SUSPEND_PREPARE” will be terminated automatically from being detected, to thereby save the memory resources of the mobile phone, and improve the response speed of the mobile phone.

FIG. 3 is a structural block diagram of an apparatus for controlling WiHD transmission on a mobile phone according to a third embodiment of the disclosure. The apparatus for controlling WiHD transmission on a mobile phone illustrated in FIG. 3 is applicable to the mobile phone, and can perform the method for controlling WiHD transmission on a mobile phone according to the embodiment illustrated in FIG. 1. The description above of the method for controlling WiHD transmission on a mobile phone according to the embodiment of the disclosure will apply to the apparatus for controlling WiHD transmission on a mobile phone according to this embodiment of the disclosure.

As illustrated in FIG. 3, the apparatus 300 for controlling WiHD transmission on a mobile phone according to this embodiment includes a first receiving module 310, a detecting module 320, and a processing module 330, where the first receiving module 310 is configured to receive a message indicating that a screen of the mobile phone becomes dark; the detecting module 320 is configured to detect a kernel notification “PM_SUSPEND_PREPARE” of the mobile phone when the first receiving module 310 receives the message indicating that the screen of the mobile phone becomes dark; and the processing module 330 is configured to switch a state of WiHD transmission on the mobile phone according to a detection result of the detecting module 320.

In an embodiment of the disclosure, the processing module 330 can include a disabling unit configured to disable WiHD transmission on the mobile phone if the detection result of the detection module 320 is that the kernel notification “PM_SUSPEND_PREPARE” is detected.

In an embodiment of the disclosure, the processing module 330 can include an enabling unit (does not shown in figures) configured to remain WiHD transmission enabled on the mobile phone if the detection result of the detection module 320 is that the kernel notification “PM_SUSPEND_PREPARE” is not detected.

With the apparatus for controlling WiHD transmission on a mobile phone according to the embodiment of the disclosure, if music is being played on the mobile phone, even if the screen of the mobile phone is dark, then WiHD transmission will still remain enabled so that the music being played on the mobile phone can be further WiHD-transmitted to thereby improve the experience of a user.

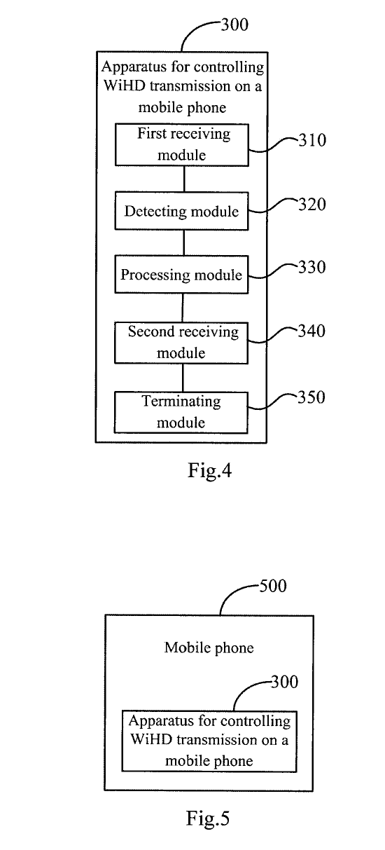

FIG. 4 is a structural block diagram of an apparatus for controlling WiHD transmission on a mobile phone according to a fourth embodiment of the disclosure. The apparatus for controlling WiHD transmission on a mobile phone illustrated in FIG. 4 is applicable to the mobile phone, and can perform the method for controlling WiHD transmission on a mobile phone according to the embodiment illustrated in FIG. 2.

As illustrated in FIG. 4, the apparatus 300 for controlling WiHD transmission on a mobile phone according to this embodiment includes a first receiving module 310, a detecting module 320, a processing module 330, a second receiving module 340, and a terminating module 350, where the first receiving module 310, the detecting module 320, and the second processing module 330 function in the same way as their counterparts in the embodiment illustrated in FIG. 3, so a repeated description thereof will be omitted here; the second receiving module 340 is configured to receive a message indicating that the screen of the mobile phone becomes bright; and the terminating module 350 is configured to terminate detecting the kernel notification “PM_SUSPEND_PREPARE” when the second receiving module 340 receives the message indicating that the screen of the mobile phone becomes bright.

With the apparatus for controlling WiHD transmission on a mobile phone according to the embodiment of the disclosure, if music is being played on the mobile phone, then even the screen of the mobile phone is dark, WiHD transmission will still remain enabled so that the music being played on the mobile phone can still be further WiHD-transmitted to thereby improve the experience of the user. Moreover with the apparatus for controlling WiHD transmission on a mobile phone according to the embodiment of the disclosure, if the screen of the mobile phone is bright, then the kernel notification “PM_SUSPEND_PREPARE” will be terminated automatically from being detected, to thereby save the memory resources of the mobile phone, and improve the response speed of the mobile phone.

FIG. 5 is a structural block diagram of a mobile phone according to a fifth embodiment of the disclosure. As illustrated in FIG. 5, the mobile phone 500 according to this embodiment includes the apparatus 300 for controlling WiHD transmission on a mobile phone, where the apparatus 300 for controlling WiHD transmission on a mobile phone can be the apparatus for controlling WiHD transmission on a mobile phone according to any one of the embodiments above of the disclosure. The apparatus 300 for controlling WiHD transmission on a mobile phone is configured: to receive a message indicating that a screen of the mobile phone becomes dark; to detect a kernel notification “PM_SUSPEND_PREPARE” of the mobile phone upon reception of the message indicating that the screen of the mobile phone becomes dark; and to switch a state of WiHD transmission on the mobile phone according to a detection result. The apparatus 300 for controlling WiHD transmission on a mobile phone can be further configured: to receive a message indicating that the screen of the mobile phone becomes bright; and to terminate detecting the kernel notification “PM_SUSPEND_PREPARE” upon reception of the message indicating that the screen of the mobile phone becomes bright.

With the mobile phone for controlling WiHD transmission on a mobile phone according to the embodiment of the disclosure, if music is being played on the mobile phone, then even the screen of the mobile phone is dark, WiHD transmission will still remain enabled so that the music being played on the mobile phone can still be further WiHD-transmitted to thereby improve the experience of the user. Moreover with the mobile phone for controlling WiHD transmission on a mobile phone according to the embodiment of the disclosure, if the screen of the mobile phone is bright, then the kernel notification “PM_SUSPEND_PREPARE” will be terminated automatically from being detected, to thereby save the memory resources of the mobile phone, and improve the response speed of the mobile phone.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for controlling Wireless High-Definition (WiHD) transmission on a mobile phone, the method comprising:
receiving a message indicating that a screen of the mobile phone becomes dark;
detecting a kernel notification “PM_SUSPEND_PREPARE” of the mobile phone upon reception of the message indicating that the screen of the mobile phone becomes dark; and
switching a state of WiHD transmission on the mobile phone according to a detection result.

2. The method according to claim 1, further comprising:
receiving a message indicating that the screen of the mobile phone becomes bright; and
terminating detecting the kernel notification “PM_SUSPEND_PREPARE” upon reception of the message indicating that the screen of the mobile phone becomes bright.

3. The method according to claim 1, wherein the switching the state of WiHD transmission on the mobile phone according to the detection result comprises:
if the detection result is that the kernel notification “PM_SUSPEND_PREPARE” is detected, disabling WiHD transmission on the mobile phone.

4. The method according to claim 1, wherein the switching the state of WiHD transmission on the mobile phone according to the detection result comprises:
if the detection result is that the kernel notification “PM_SUSPEND_PREPARE” is not detected, then remaining WiHD transmission enabled on the mobile phone.

5. An apparatus for controlling Wireless High-Definition (WiHD) transmission on a mobile phone, the apparatus comprising:
at least one processor; and
a memory communicably connected with the at least one processor for storing instructions executable by the at least one processor, wherein execution of the instructions by the at least one processor causes the at least one processor:
to receive a message indicating that a screen of the mobile phone becomes dark;
to detect a kernel notification “PM_SUSPEND_PREPARE” of the mobile phone when the message indicating that the screen of the mobile phone becomes dark is received; and
to switch a state of WiHD transmission on the mobile phone according to a detection result.

6. The apparatus according to claim 5, the at least one processor for storing instructions executable by the at least one processor, wherein execution of the instructions by the at least one processor causes the at least one processor:
to receive a message indicating that the screen of the mobile phone becomes bright; and
to terminate detecting the kernel notification “PM_SUSPEND_PREPARE” when the message indicating that the screen of the mobile phone becomes bright is received.

7. The apparatus according to claim 5, wherein the at least one instruction configured to be executed by the at least one processor to switch a state of WiHD transmission on the mobile phone according to a detection result is configured:
to disable WiHD transmission on the mobile phone if the detection result is that the kernel notification “PM_SUSPEND_PREPARE” is detected.

8. The apparatus of claim 5, wherein the at least one instruction configured to be executed by the at least one processor to switch a state of WiHD transmission on the mobile phone according to a detection result is configured:
to remain WiHD transmission enabled on the mobile phone if the detection result is that the kernel notification “PM_SUSPEND_PREPARE” is not detected.

9. A mobile phone, comprising the apparatus for controlling Wireless High-Definition (WiHD) transmission on a mobile phone according to claim 5.

10. A non-transitory computer-readable storage medium storing executable instructions that, when executed by an electronic device with a touch-sensitive display, cause the electronic device:
to receive a message indicating that a screen of the mobile phone becomes dark;
to detect a kernel notification “PM_SUSPEND_PREPARE” of the mobile phone when the message indicating that the screen of the mobile phone becomes dark is received; and
to switch a state of WiHD transmission on the mobile phone according to a detection result.

11. The non-transitory computer-readable storage medium according to claim 10, storing executable instructions that, when executed by an electronic device with a touch-sensitive display, cause the electronic device:
to receive a message indicating that the screen of the mobile phone becomes bright; and
to terminate detecting the kernel notification “PM_SUSPEND_PREPARE” when the message indicating that the screen of the mobile phone becomes bright is received.

12. The non-transitory computer-readable storage medium according to claim 10, storing executable instructions that, when executed by an electronic device with a touch-sensitive display, cause the electronic device to switch a state of WiHD transmission on the mobile phone according to a detection result is configured:
to disable WiHD transmission on the mobile phone if the detection result is that the kernel notification “PM_SUSPEND_PREPARE” is detected.

13. The non-transitory computer-readable storage medium according to claim 10, storing executable instructions that, when executed by an electronic device with a touch-sensitive display, cause the electronic device to switch a state of WiHD transmission on the mobile phone according to a detection result is configured:
to remain WiHD transmission enabled on the mobile phone if the detection result is that the kernel notification “PM_SUSPEND_PREPARE” is not detected.
